(19) United States
(12) Patent Application Publication
(10) Pub. No.: US 2013/0327758 A1
(43) Pub. Date: Dec. 12, 2013

(54) OPERATING OR ADJUSTING DEVICE HAVING USER-SPECIFIC SWITCHING AND/OR ADJUSTING FUNCTIONALITY

(71) Applicant: Norbert Bauer, Wurzburg (DE)

(72) Inventor: Norbert Bauer, Wurzburg (DE)

(73) Assignee: PREH GMBH, Bad Neustadt a.d. Saale (DE)

(21) Appl. No.: 13/978,284

(22) PCT Filed: Jan. 19, 2012
(86) PCT No.: PCT/EP2012/050809

§ 371 Date: Aug. 5, 2013

(30) Foreign Application Priority Data
Jan. 19, 2011 (DE) 10 2011 002 852.8

(51) Int. Cl. H05B 1/02; B60N 2/56

(52) U.S. Cl. CPC H05B 1/0238; B60N 2/5685
USPC 219/217

(57) ABSTRACT

The invention relates to an operating or controlling device and associated method for a motor vehicle for carrying out an operator-specific switching and/or regulating function, including: at least one operating or control element for carrying out several switching and/or regulating functions; at least one seat heater; means for generating and feeding a specific current signal into the seat heater in order to induce a specific voltage signal in the operator by means of the seat heater; detection means in order to detect the specific voltage signal upon contact with the operating element by the operator; evaluation means in order to assign a specific one of the several switching and/or regulating functions to the operating element or control element upon detection of the specific voltage signal.

### TECHNICAL FIELD

The invention relates to an operating or controlling device with an operator-dependent switching and/or regulating functionality.

### BACKGROUND

Operating devices in or for motor vehicles are known from the prior art which comprise an operator recognition device in order to carry out switching and regulating functions by means of one and the same operating element in an operator-dependent manner, i.e. depending on the seat position of the operator. For example, it is possible to provide an operating element for setting a comfort function and, depending on the detection result of which operator carried out the operation, to regulate or switch on the associated comfort function only for this operator.

According to DE 10 2008 048 820 A1 and WO 2004/078536 A1, an operator recognition can be achieved by a high-frequency signal being coupled into at least one operator. For this purpose, a recognition device of the prior art comprises at least one transmission unit coupled to a transmission electrode on or in the one or more vehicle seats in order to couple high-frequency signals generated by the transmission unit into the body of the operator sitting on the one or more vehicle seats. Moreover, at least one receiving electrode for receiving the high-frequency signals coupled into the body of the operator and transmitted by the body prior to or during an actuation of the operating element as well as an evaluation unit coupled to the receiving electrode is provided for carrying out the operator recognition by means of the received high-frequency signals. Such a process requires a large constructional effort due to the high-frequency signals used.

### BRIEF SUMMARY

The disclosure provides such an operating or controlling device with operator-specific switching and/or regulating functionalities which can be inexpensively produced due to being of a simple design.

The operating or controlling device according to the invention is provided for a motor vehicle for carrying out an operator-specific switching and/or regulating function. The terms switching and regulating function are to be construed broadly. It may, for example, relate to a comfort function that can be switched on or regulated by the operating or control element, for example, the set temperature of the seat heater. Operator-specific means, for example, that a specific one of several switching and regulating functionalities is selected dependent upon the seat position of the operator. In this case, the passenger, for example, is provided with a different switching and/or regulating functionality than the driver. For example, a specific switching or regulating functionality can be assigned to each seat or seat group (rear or front seats, for example). The term specific switching and/or regulating function also comprises blocking a or the specific functionality.

According to the invention, at least one operating or control element is provided for carrying out the several switching and/or regulating functions. The term operating element is to be construed broadly and includes any kind of command device as a so-called “man-machine interface” For example, this is a pushbutton, switch, rotating actuator and the like. In addition to the several switching and regulating functions provided according to the invention and to be carried out by the operating element, an associated function symbol, which is optionally backlit or displayed by means of an imaging device, can be provided on and in the vicinity of the operating element. According to the invention, the function symbol can be replaced by changing to another specific one of the several switching or regulating functions.

According to the invention, at least one seat heater is provided. A seat heater comprises heating wires which are, for example, incorporated into the covering of a motor vehicle seat, into the PU foam of the seat upholstery or glued onto the foam. It is operated electrically and is supposed to provide for pleasant and cozy driving comfort. The heating elements comprise flexible electrical lines that run through the covering of the seat area, the seat side supports and/or the backrest in a serpentine manner. The Joule heat effect is utilized in this case. Depending on the vehicle manufacturer or type of vehicle, the heat output can be adjusted in several stages. A multi-stage regulated seat heater, for example, is designed as follows: a rotating actuator as an operating element comprises a potentiometer. Depending on the position of the actuator, the voltage of an electrical signal is now changed, which for the electronic system associated with the seat heater serves as information for regulating the heat output. A current for the heating elements in the seats is generated from this, for example by means of pulse-width modulation. Moreover, an NTC thermistor, which is connected to the rest of the electronic regulating system and which is circuited in such a way that the heat output is interrupted starting from a certain temperature in the seat area until a cooling-off process has occurred, is located as an overheating protection device in the heating elements.

Moreover, means for generating and feeding a specific current signal into the seat heater are provided according to the invention, in order to generate a specific voltage signal in the operator by means of the seat heater, for example by means of induced eddy currents. This specific current signal can bring about the above-mentioned heating effect. As a rule, it has little or no heating effect due to the short duration of the current signal and the sluggishness of the seat heater. Specific signal within the sense of the invention means, for example, exceeding or dropping below a characteristic value, a characteristic curve and/or a characteristic repetition rate or the like.

According to the invention, detection means are furthermore provided in order to detect the specific voltage signal caused by the specific current signal when the operating element is contacted by the operator. The specific voltage signal is preferably characterized by at least its frequency, still more preferably exclusively by its frequency. Such detection means and measuring methods are known; for example, the contact surface of the operating element is configured to be conductive and connected to a measuring device. In this case, it is not an absolute requirement that the detection process has to be continued over the entire duration of the contact. Rather, a new detection process is required only in the case of a new contact.

Furthermore, evaluation means are provided according to the invention in order to assign a specific one of the several switching and/or regulating functions to the operating element upon detection of the specific voltage signal. For example, this assignment takes place at least while the operator carries out the switching or regulating function by means of the operating element or by means of the control element. In another embodiment, this assignment takes place over the duration of the contact and until a different specific voltage signal is detected. Due to the fact that, according to the invention, the seat heater, which is regularly provided in a motor vehicle, and the inductive coupling and transmission of a specific voltage signal via the operator is utilized for operator recognition, the constructional effort for producing the operating device according to the invention can be reduced and the reliability of the operator recognition can be increased.

Preferably, the specific current signal is an alternating-current signal or a pulse signal. This can be generated inexpensively. Preferably, the specific current signal is generated by controlling through a square-wave signal.

Preferably, the specific current signal respectively has a specific frequency of maximally 1000 Hz, preferably maximally 500 Hz, still more preferably maximally 400 Hz. Most preferably, the specific frequency lies in the rage of from 10 to 400 Hz, wherein the range limits are to be included with a tolerance of 5%. Advantageously, the electronic seat heater system generating the heating current, which as a rule is comparatively sluggish, can be used to generate the specific current signal without detection precision being affected thereby. This leads to more cost savings because a number of components built into the vehicle seat is reduced. Moreover, this results in a reduction of weight which also has an energy-saving effect, on the whole, on the motor vehicle. Moreover, a different specific frequency can thus be assigned to any possible seat position.

In order to increase detection accuracy, the specific current signal, in a preferred embodiment, has an amperage, optionally maximum amperage, of at least 5 A, more preferably at least 8 A, still more preferably at least 10 A.

Preferably, the operating device according to the invention in one of the above-described advantageous embodiments is used in a motor vehicle. Preferably, at least two seats are provided with one seat heater, respectively, to each of which a specific, but different, current signal is applied in order to detect the “origin” of the approach towards the detector, and in order to thereby assign the specific switching or regulating functionality to the respective operating or switching element.

Preferably, the specific current signal is generated only over the duration of a predetermined approach limit being exceeded or the duration of contact with the operating element. For example, a separate proximity or contact sensor system is provided, for example a capacitively measuring sensor. It is thus accomplished that the heating function of the seat heater is largely unaffected by the feed of the specific current signal according to the invention.

The invention further relates to a method for carrying out an operator-specific switching and/or regulating function in a motor vehicle by means of an operating element or control element comprising the following steps: generating and feeding a specific current signal into a seat heater of a motor vehicle, in order to induce a specific voltage signal into the operator by means of the changing magnetic field generated by means of the seat heater; detection by means of detection means of the specific voltage signal upon contact by the operator with the operating element; assignment of the specific one of the several switching and/or regulating functions to the operating element by means of evaluation means; carrying out or performing the operator-specific switching and/or regulating function by means of the operating element or control element. The assignment takes place at least simultaneously with carrying out the switching or regulating functionality. Due to the fact that, according to the invention, the seat heater, which is regularly provided in a motor vehicle, and the inductive coupling and induction of a specific voltage signal into the operator is utilized for operator recognition, the constructional effort for carrying out an operator-specific performance of a regulating or switching function can be reduced and the reliability of the operator recognition can be increased.

Preferably, an alternating-current signal or a pulse signal is generated as the specific current signal. According to another preferred embodiment, the means for feeding a specific current signal are controlled by means of a square-wave signal. Preferably, a specific current signal with a frequency of maximally 1000 Hz, preferably maximally 500 Hz, still more preferably maximally 400 Hz, most preferably with a frequency in the range of from 100 to 400 Hz is generated. According to another embodiment, a specific current signal with an amperage, optionally maximum amperage, of at least 5 A, more preferably at least 8 A, still more preferably at least 10 A, is generated.

The invention as well as the technical environment is explained below in more detail with reference to the figure. It must be remarked that the FIGS. 1 and 2 depict a particularly preferred embodiment of the invention, but that it is not limited thereto.

### BRIEF DESCRIPTION OF THE DRAWINGS

FIG. 1 shows an embodiment of the operating device 1 according to the invention.

FIG. 2 shows a curve over time of the specific voltage curve as it is measured by capacitive measurement on the body of AN operator during the contact with an operating element.

### DETAILED DESCRIPTION

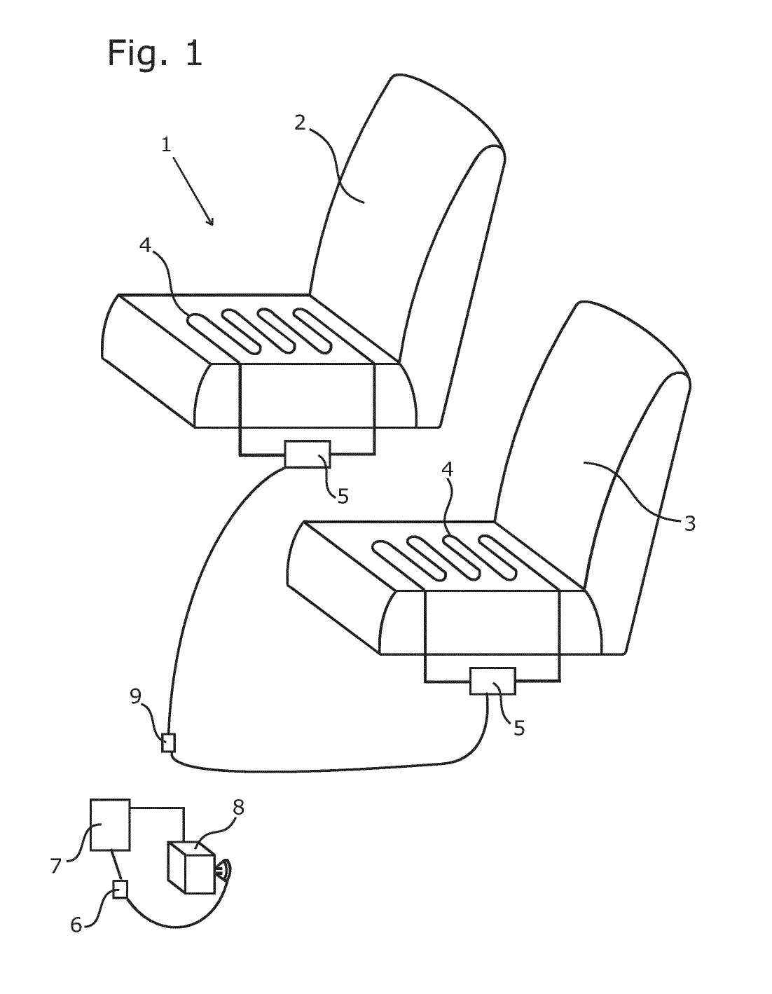

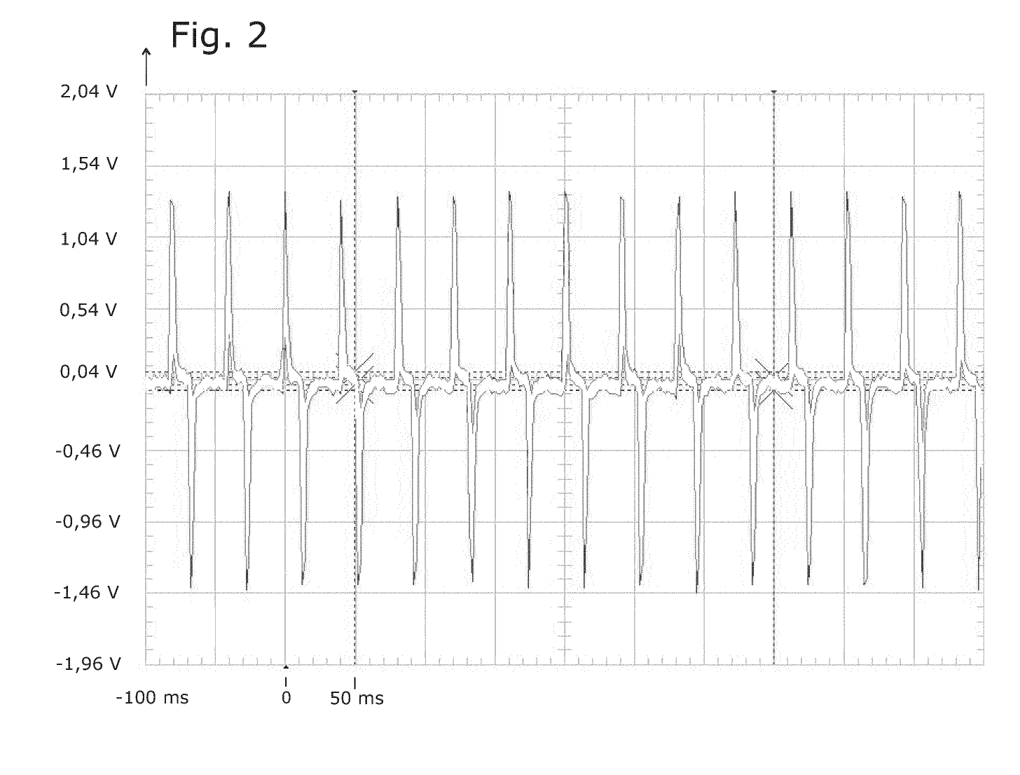

In a simplified schematic diagram, FIG. 1 shows an embodiment of the operating device 1 according to the invention. The front seats 2, 3 of a motor vehicle are each provided with a seat heater 4. The seat heater 4 is respectively supplied via power electronics 5 and, where required, with a heating current from the on-board power supply of the motor vehicle. These power electronics 5 at the same time serve for feeding a specific signal current into the seat heater 4. Depending on whether or not a heating effect is desired for the respective seat 2, 3, the signal current can also be a heating current. Preferably, the heating current is interrupted during the contact with or approach towards the operating element. The signal currents specific for each seat 2, 3 differ in at least one characteristic quantity to be detected, preferably the frequency, and induce a specific voltage signal in the operator, which in turn can be detected through one or more conductive contact surfaces on the operating element 8 and an associated detection means upon contact with the operating element 8. Depending on which operator contacts the operating element 8, the evaluation unit 7 assigns to the operating element 8 a regulating function which has been assigned in advance, i.e. has been stored and is thus specific, to the respective seat 2 or 3, for example the set temperature for the associated vehicle seat 2, 3. The feed of the signal current into the seat heaters 4 can take place continuously. Preferably, this takes place only “as required”, for example triggered by exceeding a predefined approach limit, or at least upon detection of a contact with the operating element 8 and during that. For example, a capacitive proximity sensor 9 is provided in order to detect an approach or detection. FIG. 2 shows, for example, the curve over time of the specific voltage curve as it is measured by capacitive measurement on the body of the operator during the contact with the operating element, when the seat heater is controlled by means of pulse-width modulated square-wave pulse current. However, what is depicted is the induced voltage, with the thickness of the line being supposed to indicate the measuring tolerance. Depending on the process of switching the seat heating current on or off, this induces the pulse sequence with alternating signs shown in FIG. 2 in the body of the operator. The frequency of the pulse sequence is specific to each seat and determines the assignment of the specific switching or regulating function to the operating element 8.

1. Operating or controlling device for a motor vehicle for carrying out an operator-specific switching and/or regulating function, comprising: at least one operating or control element for carrying out several switching and/or regulating functions; at least one seat heater; means for generating and feeding a specific current signal into the seat heater in order to induce a specific voltage signal in the operator by means of the seat heater; detection means in order to detect the specific voltage signal upon contact with the operating element by the operator; evaluation means in order to assign a specific one of the several switching and/or regulating functions to the operating element or control element upon detection of the specific voltage signal.

2. Operating or controlling device according to claim 1, wherein the specific current signal is an alternating-current signal or a pulse signal.

3. Operating or controlling device according to claim 1, wherein the specific current signal is generated by controlling through a square-wave signal.

4. Operating or controlling device according to claim 1, wherein the specific current signal has a specific frequency of respectively maximally 1000 Hz.

5. Operating or controlling device according to claim 1, wherein the specific current signal has an amperage of at least 5 A.

6. Operating or controlling device according to claim 1, wherein a sensor is furthermore provided in order to generate the specific current signal only over the duration of a predetermined approach limit being exceeded and/or the duration of contact with the operating element, and optionally only until the point in time at which the detection has been successfully completed.

7. Operating or controlling device according to claim 1, disposed in a motor vehicle.

8. Method for carrying out an operator-specific switching and/or regulating function by means of an operating element or control element in a motor vehicle, comprising the following steps: generating and feeding a specific current signal into a seat heater of a motor vehicle, in order to induce a specific voltage signal into the operator by means of the seat heater; detection by means of detection means of the specific voltage signal upon contact by the operator with the operating element;
assignment of a specific one of the several switching and/or regulating functions to the operating element by means of evaluation means; carrying out a specific switching and/or regulating function by means of the operating element or control element.

9. Method according to claim 8, wherein an alternating-current signal or a pulse signal is generated as the specific current signal.

10. Method according to claim 8, wherein the means for feeding a specific current signal are controlled by means of a square-wave signal.

11. Method according to claim 8, wherein a specific current signal with a specific frequency of respectively maximally 1000 Hz.

12. Method according to claim 8, wherein the specific current signal is generated with an amperage of at least 5 A.

13. Method according to claim 8, wherein the specific current signal is generated only over the duration of a predetermined approach limit being exceeded and/or the duration of contact with the operating element, and only until the point in time at which the detection has been successfully completed.
